(19) United States
(12) Patent Application Publication
(10) Pub. No.: US 2014/0360806 A1
(43) Pub. Date: Dec. 11, 2014

(54) ADHESIVE FREE ATTACHMENT OF TRANSDUCER SUSPENSION MEMBER

(71) Applicant: Gettop Europe R&D APS, Birkerød (DK)

(72) Inventors: Yao Qingshan, Skodsborg (DK); Morten Kjeldsen Andersen, Odder (DK)

(21) Appl. No.: 14/367,700

(22) PCT Filed: Dec. 21, 2012
(86) PCT No.: PCT/EP2012/076642

§ 371 Date: Jun. 20, 2014

Related U.S. Application Data
(60) Provisional application No. 61/581,546, filed on Dec. 29, 2011.

(51) Int. Cl. H04R 7/16; H04R 31/00

(52) U.S. Cl. CPC H04R 7/16; H04R 31/003
USPC 181/172; 29/594

(57) ABSTRACT

The present invention relates to a suspension member for suspending a moveable piston structure of a transducer, the suspension member comprising an attachment region comprising an elastomeric material, wherein at least part of the attachment region is shaped in a manner so as to be able to attach to a fixed portion of the transducer in an adhesive free manner. Moreover, the present invention relates to a suspension member comprising an integrated tolerance compensation means.

### FIELD OF THE INVENTION

The present invention relates to an adhesive free suspension member for transducers, such as miniature loudspeakers. In particular, the present invention relates to suspension members having attachment regions that facilitate mounting of said suspension members to for example transducer frames without using glue or similar adhesives.

### BACKGROUND OF THE INVENTION

Glue or similar adhesives have been widely applied in transducer assembling processes over the years. In particular, transducer diaphragms are normally attached to transducer frames by the use of glue or similar adhesives. Moreover, piston structures are typically glued to suspension members.

It is well-known that the use of glue or similar adhesives has at least two immediate advantages, namely
1. The assembling process of transducers becomes more complicated and cost consuming, and
2. Surplus glue on suspension members and piston structures may influence on the acoustical performance of the transducer.

Thus, the use of glue or similar adhesives should be avoided if possible.

It may be seen as an object of embodiments of the present invention to provide an adhesive free assembling process of transducers, such as miniature transducers.

It may be seen as a further object of embodiments of the present invention to provide an adhesive free attachment of the moveable diaphragm to the transducer frame.

It may be seen as a still further object of embodiments of the present invention to provide an adhesive free attachment of the suspension member to the piston structure.

### DESCRIPTION OF THE INVENTION

The above-mentioned objects are complied with by providing, in a first aspect, a suspension member for suspending a moveable piston structure of a transducer, the suspension member comprising an attachment region comprising an elastomeric material, wherein at least part of the attachment region is shaped in a manner so as to be able to attach to a fixed portion of the transducer in an adhesive free manner.

Thus, the first aspect of the present invention relates to a suspension member for suspending a moveable piston structure in a transducer, such as a miniature loudspeaker suitable for applications in cell phones, tablets, portable game consoles, laptops and similar devices.

It is an advantage of the suspension member according to the present invention that it connects to a fixed portion of the transducer, such as a transducer frame, in an adhesive free manner, i.e. without the use of for example glue or any other sticking adhesive.

As stated above, the fact that the suspension member may be attached in a glue (or the like) free manner has at least two immediate advantages. Firstly, the assembling process of transducers becomes less complicated and therefore more cost efficient, and secondly the influence of surplus glue on suspension members and piston structures can be avoided.

The suspension member may further comprise a piston region adapted to be attached to the moveable piston structure. The suspension member and the moveable piston structure attached thereto form a complete diaphragm in combination. The piston region may optionally be shaped in a manner so as to be able to attach to the moveable piston structure in an adhesive free manner.

The adhesive free attachment between the piston region and the moveable piston structure may be achieved by clamping.

Moreover, a flexible member connecting the attachment region and the piston region may be provided as well.

The attachment region, the piston region and the flexible member may form an integrated one-piece structure. Preferably, the attachment region, the piston region and the flexible member form an integrated silicone one-piece structure, i.e. an integrated silicone-based suspension member. The elastic properties of the silicone allow that the suspension may be attached to for example the transducer frame without using glue or a similar adhesive.

The adhesive free attachment may be implemented in various ways.

In one embodiment the attachment region is formed as a clamping region adapted to hold onto the fixed portion of the transducer. The clamping region may, in a cross-sectional profile, comprise an inner and an outer structure being separated by a hollow portion adapted to receive the fixed portion of the transducer. In this embodiment proper clamping to the fixed portion of the transducer may be ensured by the elastic properties of the inner and outer structures of the clamping region.

In another embodiment the attachment region may, in a cross-sectional profile, be formed as a protrusion comprising an o-ring shaped structure adapted to fit into a corresponding recess in the fixed portion of the transducer. During fixation of the suspension member to the fixed portion of the transducer the o-ring shaped structure of the attachment region is compressed within the recess of the fixed portion.

In a still further embodiment the suspension member may comprise tolerance compensation means being formed as a flexible extending structure in a direction so as to form an acoustical seal between a front chamber and a back chamber. The aim of the tolerance compensation means is to compensate for manufacturing and, in particular, assembling tolerances.

The tolerance compensation means is adapted to abut a planar structure, such as an inner surface of a cell phone cover, so as form the before-mentioned acoustical seal between the front chamber and the back chamber, wherein the front chamber may be defined as an acoustically sealed chamber defined by an upper surface of the piston structure, the suspension member, the tolerance compensation means and the planar structure in combination. The back chamber may be defined as an acoustical chamber being in acoustical communication with a lower surface of the piston structure.

In order to establish the acoustical seal the flexible extending structure may extend primarily in a direction being essentially parallel to the direction of movement of the moveable piston structure. Preferably, the flexible extending structure comprises an elastomeric material, such as silicone. Moreover, flexible extending structure may form an integrated part of the suspension member.

In a second aspect the present invention relates to a suspension member for suspending a moveable piston structure of a transducer, the suspension member comprising tolerance compensation means comprising an elastomeric material, said tolerance compensation means being formed as a structure extending in a direction so as to form an acoustical seal between a first chamber and a second chamber.

The suspension member and the tolerance compensation means may form a one-piece structure. The first and second chambers may comprise a front chamber and a back chamber, respectively.

As previously mentioned the aim of the tolerance compensation means is to compensate for manufacturing and, in particular, assembling tolerances when transducer are mounted in portable devices, such as cell phones, tablets, laptops etc.

The suspension member may further comprise an attachment region comprising an elastomeric material, wherein at least part of the attachment region is shaped in a manner so as to be able to attach to a fixed portion of the transducer in an adhesive free manner. Moreover, a piston region adapted to be attached to the moveable piston structure may be provided. The piston region may be shaped in a manner so as to be able to attach to the moveable piston structure in an adhesive free manner. Finally, the suspension member may further comprise a flexible member connecting the attachment region and the piston region.

The tolerance compensation means, the attachment region, the piston region and the flexible member may form an integrated one-piece structure. Preferably, the tolerance compensation means, the attachment region, the piston region and the flexible member form an integrated silicone one-piece structure.

In a third aspect the present invention relates to a diaphragm comprising a suspension member according to the first or second aspects, said diaphragm further comprising a moveable piston structure attached to a piston region of said suspension member. The moveable piston structure may be in the form of a mica sheet, i.e. a sheet of silicate minerals, or any other thin, stiff and light weight material.

In a fourth aspect the present invention relates to a transducer comprising a diaphragm according to the third aspect, said transducer further comprising a voice coil attached to a moveable piston structure, and drive means for moving the diaphragm in response to incoming electrical signals.

In a fifth aspect the present invention relates to a portable communication or gaming device comprising a transducer according to the fourth aspect.

In a sixth and final aspect the present invention relates to a method for attaching a suspension member to a fixed portion of a miniature transducer in an adhesive free manner, said suspension member comprising an attachment region of an elastomeric material being shaped so as to be able to engage with the fixed portion of the transducer, the method comprising the step of bringing the attachment region and the fixed portion of the transducer into engagement.

The engagement may be established by clamping the attachment region onto the fixed portion of the transducer as depicted in FIGS. 1, 5 and 6. Alternatively, the engagement may be established by positioning the attachment region into a recess formed in the fixed portion of the transducer as depicted in FIGS. 2-4.

Additional fixation of the attachment region to the fixed portion of the transducer may subsequently be provided by applying adhesives, such as glue.

### BRIEF DESCRIPTION OF THE DRAWINGS

The present invention will now be explained in further details with reference to the accompanying figures, wherein

FIG. 1 shows a cross-sectional view of a transducer comprising a suspension member according to a first embodiment,

FIG. 2 shows a cross-sectional view of a suspension member according to a second embodiment,

FIG. 3 shows a cross-sectional view of a suspension member according to a third embodiment,

FIG. 4 shows a cross-sectional view of a suspension member according to a fourth embodiment,

FIG. 5 shows a cross-sectional view of a transducer comprising a suspension member having tolerance compensation means of a first type,

FIG. 6 shows a cross-sectional view of a transducer comprising a suspension member having tolerance compensation means of a second type, and

FIG. 7 shows a cross-sectional view of a transducer comprising a suspension member having tolerance compensation means of the first type.

While the invention is susceptible to various modifications and alternative forms, specific embodiments have been disclosed by way of examples. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION OF THE DRAWINGS

In its most general aspect the present invention relates to a suspension member of an elastomeric material, such as silicone. The elastomeric properties of the elastomeric material is utilized for providing an adhesive free attachment of the suspension member to a transducer frame and/or an adhesive free attachment of the suspension member to a moveable piston structure. Additional fixation may subsequently be provided by applying adhesives, such as glue. Thus, the adhesive free attachment constitutes the main fixation, whereas an optional, subsequent adhesive-based fixation constitutes an assisting or secondary fixation.

Optionally the suspension member according to the present invention can be equipped with an arrangement for compensating for manufacturing and, in particular, assembling tolerances.

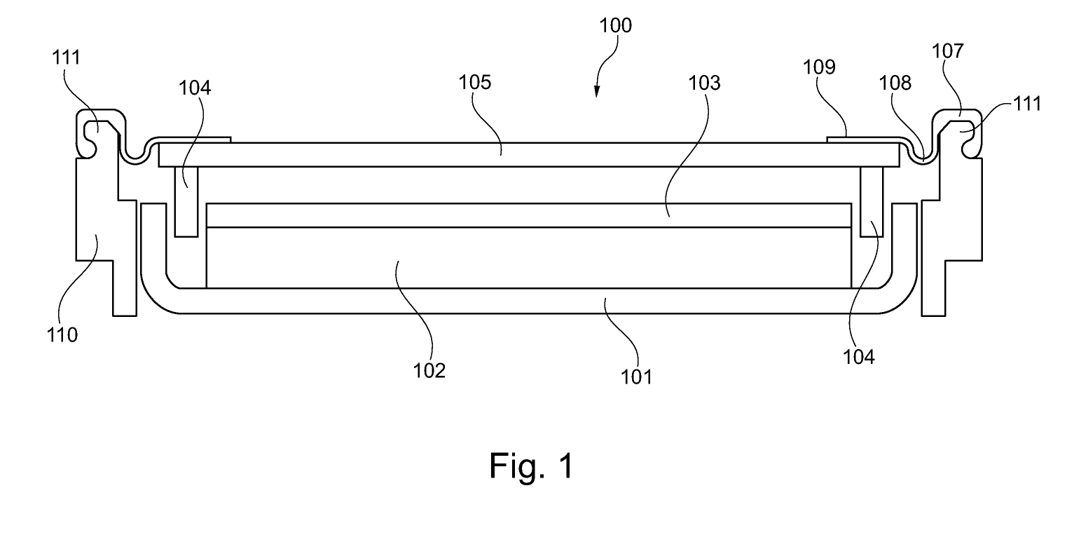

FIG. 1 shows a cross-sectional view of a miniature transducer 100 comprising a magnetic system comprising a permanent magnet 102 and inner 103 and outer pole pieces 101. The piston structure 105 is suspended in a suspension member comprising an attachment region 107, a piston region 109 and a flexible member 108 connecting the two. A voice coil 104 is attached to the piston structure 105.

The overall shape of the miniature transducer depicted in FIG. 1 may in principle be arbitrary including rectangular, circular and elliptical shapes. The individual dimensions (length, width or diameter) of the transducers are typically in the range of 8-20 mm. The height of a typical transducer is normally in the range 2-5 mm. However, it should be noted that the dimensions of miniature transducers may vary from these ranges. The present invention is thus not limited to transducers having dimensions strictly falling within these ranges.

Transducers of the kind depicted in FIG. 1 find their primary use as high efficient miniature loudspeakers in compact devices, such as cell phones, tablets, game consoles, laptops etc. They are typically sandwiched between a printed circuit board (PCB) and an inner surface portion of a cover of these compact devices.

As previously mentioned the suspension member comprises an attachment region 107, a piston region 109 and a flexible member 108 connecting the two. The attachment region 107 fixates the suspension member to a frame portion 110 of the transducer without using glue or any other adhesive. The glue free attachment of the suspension member to the frame portion also facilitates that the suspension member may be repositioned or adjusted after being over/around a top portion 111 of the transducer frame 110. The possibility of repositioning the suspension member is advantageous to conventional adhesive-based techniques.

The attachment region 107 of the suspension member is made of an elastomeric material, such as for example silicone. The elastic properties of the attachment region 107 ensure that the suspension member maintains properly clamped onto the top portion 111 of the transducer frame 110. Optionally, additional fixation of the attachment region 107 to the transducer frame 110 may be provided by applying adhesives, such as glue, after clamping the attachment region 107 to the top portion 111.

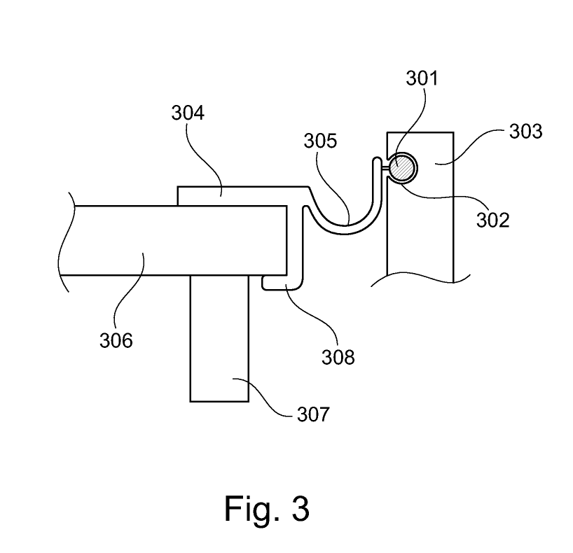

The piston region 109 is attached to the piston structure 105 using either an adhesive-based process, such as gluing, or an adhesive free arrangement, cf. FIG. 3.

Preferably, the attachment region 107, the piston region 109 and the flexible member 108 connecting the two are integrated in a one-piece component made of an elastomeric material, such as silicone. Preferably, the elastomeric material has a hardness of Shore 40-80. The thicknesses of the attachment region 107, the piston region 109 and the flexible member 108 connecting the two typically fall within the range 0.07-0.2 mm.

It is an advantage that silicone is suitable for mass production processes, such as manufacturing processes involving injection moulding processes.

The flexible member 108 allows that the piston structure 105 and the voice coil 104 attached thereto can move essentially freely when a drive current is applied to the voice coil 104. The piston structure is typically constituted by a thin sheet of mica.

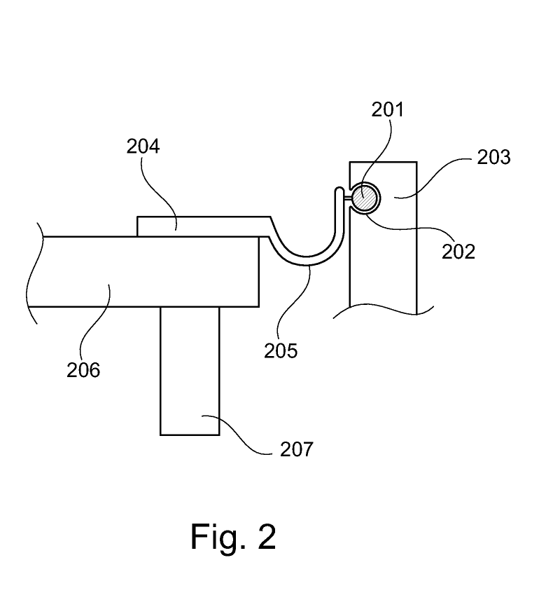

FIG. 2 shows an alternative embodiment of the attachment region 201 of a one-piece silicon-based suspension member. As depicted in FIG. 2 an o-ring shaped attachment region 201 fits into a corresponding recess 202 in the transducer frame 203. The o-ring is compressed and its elastic properties ensure that it is maintained in a fixed position in the recess 202. Optionally, additional fixation of the attachment region 201 to the transducer frame 203 may be provided by applying adhesives, such as glue, after positioning the attachment region 201 into the recess 202. The implementations and functionalities of the piston region 204, the flexible member 205, the voice coil 207 and the piston structure 206 are similar to the embodiment depicted in FIG. 1.

FIG. 3 shows an alternative embodiment of the piston region 304, 308 of a one-piece silicon-based suspension member. Similar to FIG. 2, FIG. 3 shows an o-ring shaped attachment region 301 that fits into a corresponding recess 302 in the transducer frame 303. The o-ring is compressed and its elastic properties ensure that it is maintained in a fixed position in the recess 302. FIG. 3 shows an adhesive free piston region comprising a clamping arrangement where the piston structure 306 is clamped and thereby fixated between the upper 304 and lower 308 part of the piston region. Thus, it is the elastic properties of the piston region that ensures that the piston structure 306 is properly clamped to the suspension member.

Optionally, additional fixation of the attachment region 301 to the transducer frame 303 may be provided by applying adhesives, such as glue, after positioning the attachment region 301 in the recess 302. Moreover, additional fixation between the piston region 304, 308 and the piston 306 may be provided by applying adhesives, such as glue, after positioning the piston 306 between the upper 304 and lower 308 parts of the piston region.

The implementations and functionalities of the flexible member 305, the voice coil 307 and the piston structure 306 are similar to the embodiment depicted in FIG. 1.

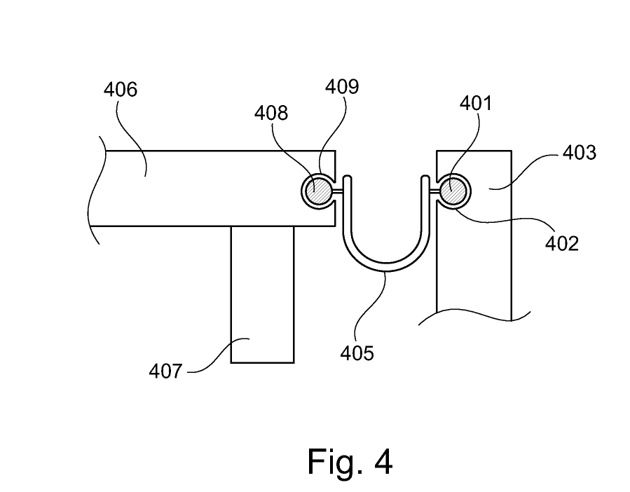

FIG. 4 shows yet another embodiment of the piston region 304, 308 of a one-piece silicon-based suspension member. Similar to FIGS. 2 and 3, FIG. 4 shows an o-ring shaped attachment region 401 that fits into a corresponding recess 402 in the transducer frame 403. The o-ring 401 is compressed and its elastic properties ensure that it is maintained in a fixed position in the recess 402. Moreover, FIG. 4 shows an adhesive free piston region comprising an o-ring shaped piston region 408 that fits into a corresponding recess 409 in the piston structure 406. Similar to the attachment region 401 the o-ring 408 is compressed and its elastic properties maintain its position in the recess 409. The implementations and functionalities of the flexible member 405 and the voice coil 407 are similar to the embodiment depicted in FIG. 1.

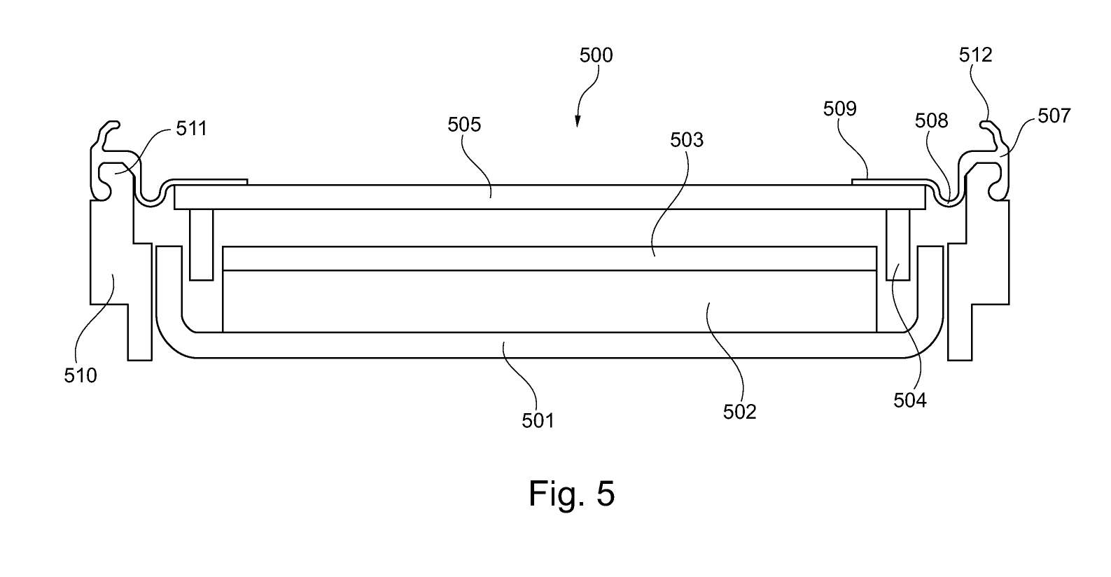

FIG. 5 shows a cross-sectional view of a miniature transducer 500 similar to the one shown in FIG. 1. Thus, the transducer 500 shown in FIG. 5 comprises a magnetic system comprising a permanent magnet 502 and inner 503 and outer pole pieces 501. The piston structure 505 is suspended in a suspension member comprising an attachment region 507, a piston region 509 and a flexible member 508 connecting the two. A voice coil 504 is attached to the piston structure 505. The attachment region 507 attaches to the top 511 of the transducer frame 510 as disclosed in connection with FIG. 1.

The suspension member shown in FIG. 5 further comprises tolerance compensation means 512 for compensating for manufacturing and/or assembling tolerances. In particular, assembling tolerances may influence the available space at the intended position of a transducer within for example compact cell phones. Thus, even though transducers are typically mounted directly on PCBs the distance to an inner surface of a cell phone cover may vary from one cell phone to another cell phone. This varying distance between PCB and cover is compensated for by the flexible tolerance compensation means 512.

The tolerance compensation means 512 shown in FIG. 5 is a flexible structure that preferably forms an integral part of the one-piece silicone-based suspension member in FIG. 5. The aim of the tolerance compensation means 512 is to form an acoustical seal between a front chamber and a back chamber when the transducer is mounted in portable devices, such as in cell phones, tablets, laptops etc.

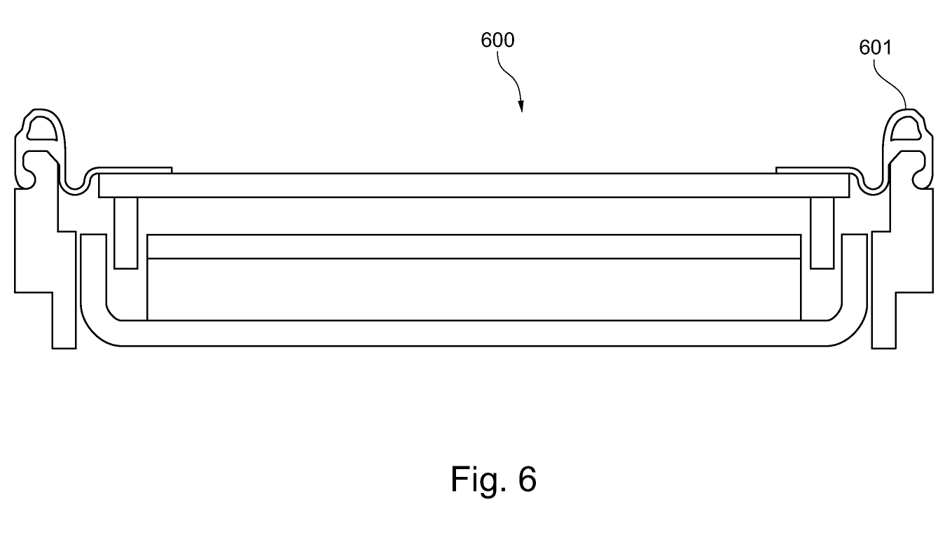

FIG. 6 shows a cross-section view of a miniature transducer 600 of the same type as shown in FIGS. 1 and 5. Compared to the transducer shown in FIG. 5 the shape of the tolerance compensation means 601 has been changed to a more robust shape. In a first embodiment the tolerance compensation means 601 shown in FIG. 6 comprises a hollow core region and thereby forms a relatively soft structure. In a second embodiment the tolerance compensation means may be a solid structure forming a relatively hard structure.

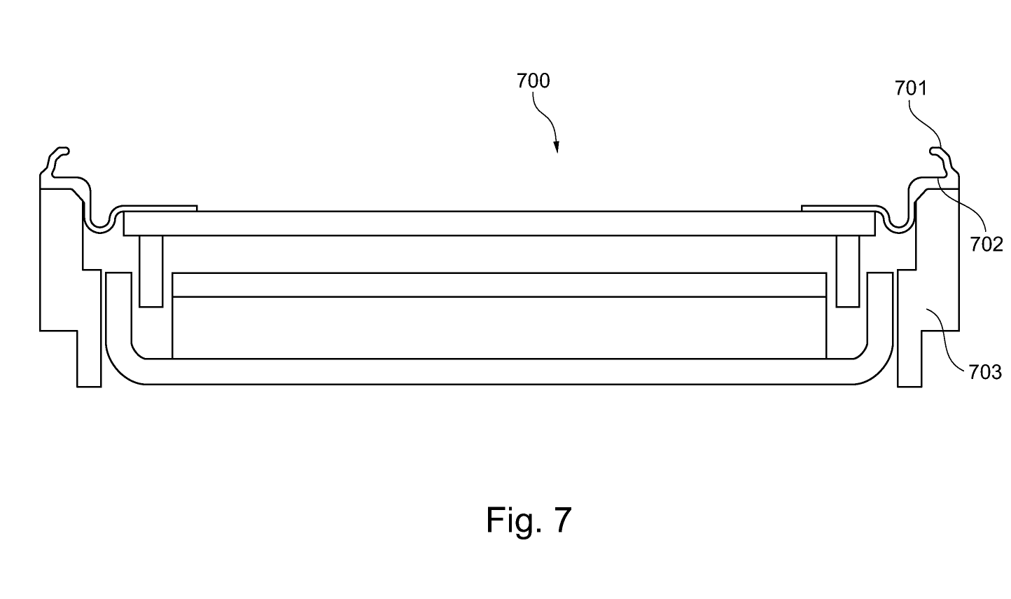

FIG. 7 shows a cross-sectional view of a miniature transducer 700 of the same type as shown in FIGS. 1, 5 and 6. The transducer shown in FIG. 7 applies a silicone-based suspension member comprising integrated tolerance compensation means 701. In contrast to the previous embodiments the attachment region 702 of the suspension member shown in FIG. 7 is attached to the transducer frame 703 using an adhesive, such as glue.

1. A suspension member for suspending a moveable piston structure of a transducer, the suspension member comprising an attachment region comprising an elastomeric material, wherein at least part of the attachment region is shaped in a manner so as to be able to attach to a fixed portion of the transducer in an adhesive free manner.

2. A suspension member according to claim 1, further comprising a piston region adapted to be attached to the moveable piston structure.

3. A suspension member according to claim 2, wherein the piston region is shaped in a manner so as to be able to attach to the moveable piston structure in an adhesive free manner.

4. A suspension member according to claim 2, further comprising a flexible member connecting the attachment region and the piston region.

5. A suspension member according to claim 4, wherein the attachment region, the piston region and the flexible member form an integrated one-piece structure.

6. A suspension member according to claim 4, wherein the attachment region, the piston region and the flexible member form an integrated silicone one-piece structure.

7. A suspension member according to claim 1, wherein the attachment region is formed as a clamping region adapted to hold onto the fixed portion of the transducer.

8. A suspension member according to claim 7, wherein the clamping region, in a cross-sectional profile, comprises an inner and an outer structure being separated by a hollow portion adapted to receive the fixed portion of the transducer.

9. A suspension member according to claim 8, wherein the elastic properties of the inner and outer structures of the clamping region ensure proper clamping to the fixed portion of the transducer.

10. A suspension member according to claim 8, wherein the attachment region, in a cross-sectional profile, is formed as a protrusion comprising an o-ring shaped structure adapted to fit into a corresponding recess in the fixed portion of the transducer.

11. A suspension member according to claim 1, further comprising tolerance compensation means being formed as a flexible extending structure in a direction so as to form an acoustical seal between a front chamber and a back chamber.

12. A suspension member according to claim 11, wherein the flexible extending structure extends primarily in a direction being essentially parallel to the direction of movement of the moveable piston structure.

13. A suspension member according to claim 11, wherein the flexible extending structure comprises an elastomeric material, such as silicone, and forms an integrated part of the suspension member.

14. A diaphragm comprising a suspension member according to claim 1, said diaphragm further comprising a moveable piston structure attached to a piston region of said suspension member.

15. A transducer comprising a diaphragm according to claim 14, said transducer further comprising a voice coil attached to a moveable piston structure, and drive means for moving the diaphragm in response to incoming electrical signals.

16. A portable communication or gaming device comprising a transducer according to claim 15.

17. A method for attaching a suspension member to a fixed portion of a miniature transducer in an adhesive free manner, said suspension member comprising an attachment region of an elastomeric material being shaped so as to be able to engage with the fixed portion of the transducer, the method comprising the step of bringing the attachment region and the fixed portion of the transducer into engagement.

18. A method according to claim 17, wherein the engagement is established by clamping the attachment region onto the fixed portion of the transducer.

19. A method according to claim 17, wherein the engagement is established by positioning the attachment region into a recess formed in the fixed portion of the transducer.

20. A method according to claim 17, further comprising the step of applying an adhesive for additional fixation of the attachment region to the fixed portion of the transducer.
